(19) United States
(12) Patent Application Publication
(10) Pub. No.: US 2018/0046319 A1
(43) Pub. Date: Feb. 15, 2018

(54) METHOD TO ADJUST THRESHOLDS ADAPTIVELY VIA ANALYSIS OF USER'S TYPING

(71) Applicant: LENOVO (SINGAPORE) PTE. LTD., Singapore (SG)

(72) Inventors: Jun Luo, Yokohama-shi (JP); Hiroshi Itoh, Sagamihara-shi (JP)

(73) Assignee: LENOVO (SINGAPORE) PTE. LTD., SINGAPORE (SG)

(21) Appl. No.: 15/233,771

(22) Filed: Aug. 10, 2016

(51) Int. Cl. G06F 3/041; G06F 3/0488; G06F 3/044

(52) U.S. Cl. CPC G06F 3/0418; G06F 3/044; G06F 3/04886

(57) ABSTRACT

Disclosed is a method for determining an intentional touching event on a touchscreen, including a touchscreen virtual keyboard, by individualizing and/or adjusting a touch signal threshold value to obtain a calibrated value, wherein the touch signal threshold value is used in determining an intentional touching event by determining if a strength of a touch signal associated with a touching event falls above or below the calibrated threshold value. Adjusting the touch signal threshold value may be based on the user's active input, and may be statistically determined based on at least one sample of touch signal values.

### BACKGROUND OF THE INVENTION

The present invention generally relates to touchscreen systems, and more particularly to an apparatus and method for more reliably detecting a user's screen touch for on-screen typing and other touchscreen functions.

Touchscreen enabled devices may typically include a virtual keyboard provided on a touchscreen, also known as an On Screen Keyboard, or Soft keyboard. Such devices may include, for example, tablets, or clamshell devices, and may including a main screen and sub-screen surface with a virtual keyboard in the sub-screen, instead of a physical keyboard.

A virtual keyboard may include distinct sensing areas on a touchscreen, which may be configured, for example, in a keyboard layout, wherein each sensing area may be configured to detect an input based on a touching event, such as a tap or swipe by a user's finger or other touchscreen input device (e.g. stylus, touchscreen gloves, etc.).

However, touch detection methods may fail to accurately detect a user's intended touch, or may detect an unintended touch as an intended touch, leading to user frustration and dissatisfaction. As such, there is a need for more accurate methods of reliably detecting and interpreting a user's intentional and unintentional touches on a touchscreen.

### SUMMARY OF THE INVENTION

In one aspect of the present invention, a touchscreen device comprises: a touch sensitive screen; and a processor configured to receive a touch signal effectuated by a user touching event, through the touch sensitive screen,

wherein the touch sensitive screen enables a user to control processing functions of the processor through a detected intentional touching event effectuated by the user, wherein the processor is configured to determine whether the touch signal is associated with an intentional touching event by determining whether a touch strength signal value of the touch signal is above or below a touch signal threshold value, wherein a touch strength signal value above the touch signal threshold value is determined to be associated with an intentional touching event, wherein the touch signal threshold value is calibrated by the processor based on user touchscreen input by: collecting at least one sample of touch strength signal values over at least one user input session; analyzing the at least one sample to determine if an initial touch signal threshold value requires adjusting, wherein analyzing the at least one sample comprises determining a central value based on a statistical analysis of the at least one sample of touch strength signal values; and determining a calibrated touch signal threshold value based on the analysis of the at least one sample, wherein the calibrated touch strength signal value may be the initial touch signal threshold value, or an adjusted touch strength signal value based on the central value, and wherein the calibrated touch signal threshold value is used in determining an intentional touching event.

In another aspect of the present invention, a computer-implemented method for determining an intentional touching event on a touchscreen device, comprises executing on a processor of the device the steps of: receiving, by a processor, a touch signal effectuated by a user touching event, through a touch sensitive screen of the touchscreen device, the touch signal having a touch signal value; comparing, by the processor, a strength of the touch signal value associated with the touching event to a calibrated touch signal threshold value, wherein the calibrated touch signal threshold value is determined by adjusting a touch signal threshold value based on a user's active input through the touch sensitive screen of the touchscreen device; determining, by the processor, if the touching event is an intentional or unintentional touching event, wherein if the strength of the touch signal value falls below the calibrated touch signal threshold value, the touching event is determined to be unintentional; and enabling the user to control a processing function of the touchscreen device, the processing function being associated with the user touching event, if the touching event is determined to be intentional.

In yet another aspect of the present invention, a non-transient computer readable medium contains program instructions for causing a computer to perform a method of determining an intentional touching event on a touchscreen, the method comprising: receiving a touch signal effectuated by a user touching event, through a touch sensitive screen of the touchscreen device, the touch signal having a touch signal value; comparing a strength of the touch signal value associated with the touching event to a calibrated touch signal threshold value, wherein the calibrated touch signal threshold value is determined by adjusting a touch signal threshold value based on a user's active input through the touch sensitive screen of the touchscreen device; determining if the touching event is an intentional touching event, wherein if the strength of the touch signal value falls above the calibrated touch signal threshold value, the touching event is determined to be intentional; and enabling the user to control a processing function of the touchscreen device associated with the user touching event, if the touching event is determined to be intentional.

These and other features, aspects and advantages of the present invention will become better understood with reference to the following drawings, description and claims.

### BRIEF DESCRIPTION OF THE DRAWINGS

FIG. 1 illustrates a display of a touchscreen device including a virtual keyboard;

FIG. 2 illustrates a touch sensing method comprising capacitance sensing;

FIG. 3 is a graph showing variations in touch strength versus a touch signal threshold value; and

FIG. 4 is a flow chart illustrating a method for determining an intentional touching event on a touchscreen, in accordance with an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims. However, any single inventive feature may not address any of the problems discussed above or may only address one of the problems discussed above. Further, one or more of the problems discussed above may not be fully addressed by any of the features described below.

Various inventive features are described below that can each be used independently of one another or in combination with other features.

Broadly, the present invention provides a method and apparatus for determining an intentional touching event on a touchscreen, including a touchscreen virtual keyboard, by individualizing and/or adjusting a touch signal threshold value to obtain a calibrated value, wherein the touch signal threshold value is used in determining an intentional touching event by determining if a strength of a touch signal associated with a touching event falls above or below the calibrated threshold value. Adjusting the touch signal threshold value may be based on the user's active input, and may be statistically determined based on at least one sample of touch signal values. The present invention further provides a non-transient computer readable medium containing program instructions for causing a computer to perform the method of determining an intentional touching event on a touchscreen.

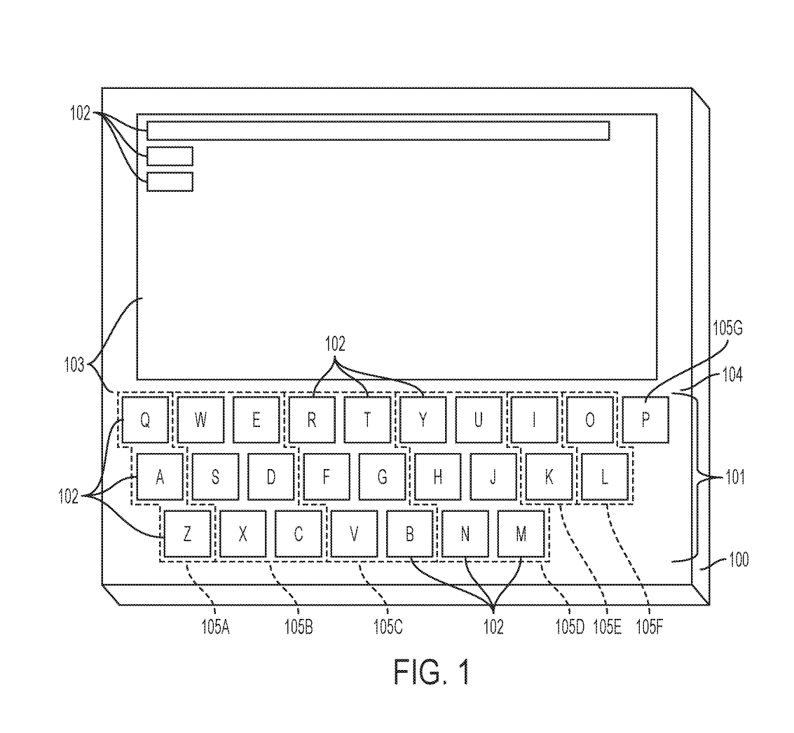

As shown in FIG. 1, a touchscreen device 100, which may be a computer, comprising a touch sensitive screen 104, may allow a user to interact and control various processing functions of the device 100 by touching distinct sensing areas 102 associated with various processing functions. A visual display 103 on the screen 104 may allow the user to recognize the function(s) associated with the sensing area(s) 102, so that the user can touch the appropriate sensing area(s) 102 to effectuate the desired function(s), as is known in the art.

For example, the device 100 may display a virtual keyboard 101, which may have a size and layout similar to a physical keyboard (e.g., QWERTY layout) allowing the user to “type” by touching the virtually displayed alphanumeric keys, wherein a distinct sensing area 102 may be associated with each key.

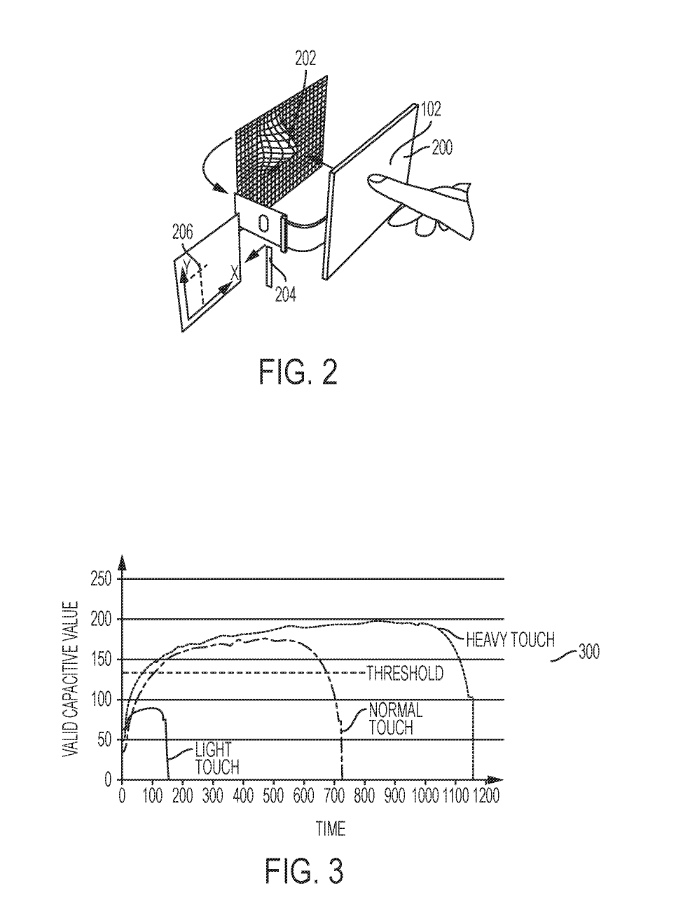

Typical methods of detecting a user's touch or a “touching event” at sensing area 102 may include sensing a signal associated with a touch or a “touch signal.” For example, as shown in FIG. 2, in capacitance sensing methods, a touch signal may be a capacitive signal effectuated by a touch against a touchscreen sensor 200, which may generate an electrostatic field 202. A controller 204 may scan the capacitive signals to determine an actual touch point 206, as is known in the art. The touch signal may be associated with a touch signal strength, which may be correlated to the intensity of the electrostatic field. As such, a light touch may generate a low touch signal strength (e.g., a low capacitance signal), and a heavy touch may generate a high touch signal strength (e.g., a high capacitance signal).

As shown in the graph 300 of FIG. 3, a threshold value of the touch signal strength or “touch signal threshold value” may be used to differentiate, by a processor of the device 100, between an intentional touch and an unintentional touch, wherein a touch signal strength value (e.g., capacitance signal value) below the threshold value (i.e., light touch), may indicate an unintentional touch, and a touch signal strength value above the threshold value (i.e., heavy touch) may indicate an intentional touch.

However, whether the input instrument is the user's finger or other input device, the touch signal strength may be affected by various factors such as user touch strength, finger size, positioning of the touchscreen device, condition of the input instrument, temperature, substance on the instrument or finger which may affect conductivity, etc. Therefore, a single fixed touch signal threshold value may not be an accurate indicator on which to base a determination of an intentional touching event, and may lead to different users experiencing a different responsiveness based on individual factors specific to each user.

To improve the accuracy of determining an intentional touching event on a touchscreen, the present invention adjusts a touch signal threshold value, based on a user's input.

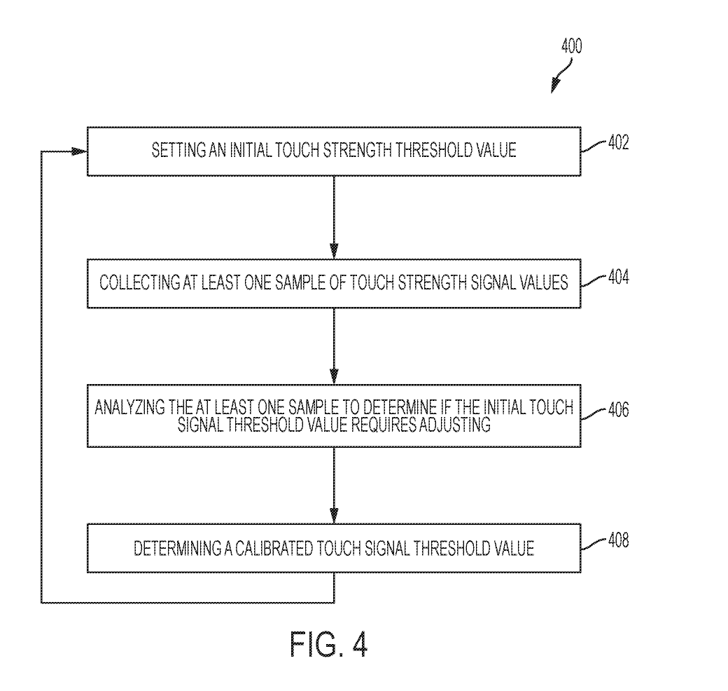

FIG. 4 shows a flow chart for a method 400 of determining an intentional touching event on a touchscreen, in accordance with various embodiments. The method 400, which may be carried out by a processor of the device 100, may comprise setting an initial touch strength threshold value (step 402); collecting at least one sample of touch strength signal values (step 404), which may be capacitance values, collected over at least one user input session; analyzing the at least one sample to determine if the initial touch signal threshold value requires adjusting (406); and determining a calibrated touch signal threshold value (step 408) based on the determination made in step 406, wherein the calibrated value may be the initial touch signal threshold value set in step 402, or a new adjusted value, and wherein the calibrated touch signal threshold value is used in determining an intentional touching event. The method 400 may further include repeating steps 402, 404, 406, and 408, wherein the initial touch signal threshold value set in step 402 may be a previously calibrated value. Additionally, the touch signal threshold value may be function specific, touch manner specific, and/or user specific, as will be explained below.

Step 402 of setting an initial touch strength threshold value may comprise setting the threshold as a minimum valid value. Thus, the initial touch signal threshold value set in step 402 may be at least a minimum value for a detectable signal. Additionally, a user may be provided with an option to reset the threshold value to an initial minimum value for recalibration.

Step 404 of collecting at least one sample of touch strength signal values may comprise gathering the user's capacitance values. The sample of touch strength signal values obtained in step 404 may include any number of signal values sufficient to be statistically analyzed. The sample values may be collected over an input session, or over various sessions. An input session may be a period of time over which a user provides multiple inputs, with a short time lapse (e.g., <1 second) separating the inputs. An input session may also comprise only a single input.

An input session may comprise user input related to a specific function of the device (“function specific input”).

For example, a function specific input session may comprise a user typing on a virtual keyboard 101, playing a video game, internet surfing, dialing or texting, unlocking the device (which may comprise a single input such as a swipe), or using a downloaded application, etc. Accordingly, the touch signal threshold value may be function specific. For example, different threshold values may be determined for different functions, such as typing on a virtual keyboard, internet surfing, unlocking the device, etc.

Additionally, a touch signal threshold value may be touch manner specific. For example, in typing on a virtual keyboard, a user may typically use different fingers for different regions (i.e. regions 105A-105G, shown in FIG. 1) on the keyboard 100, and touch signal strength may vary based on these different regions. Touch signal strength may also vary based on the specific key. As such, different threshold values may be determined for different keyboard regions and/or individual keys. Other touch manner factors may comprise whether or not the device includes a transparent cover over the touch panel, positioning (i.e. tilt) of the device, type of input instrument (i.e. stylus, finger, touchscreen gloves, etc.), condition of the input instrument, etc., according to various embodiments.

Additionally, as it is possible for a device to be used by different individuals, a touch signal threshold value may also be user specific, wherein a user may be asked to identify him/herself prior to using the touchscreen device, and wherein the calibrated touch signal threshold values(s) may be associated with a specific user.

Step 406 of analyzing the at least one sample may comprise performing a statistical analysis on the sample values, which may comprise a normal (Gaussian) distribution, or other statistical analysis method (e.g., other distribution, individual/moving-range chart, etc.). Based on the statistical analysis, a tentative touch signal threshold value may be determined. For example, the tentative threshold may be at least two standard deviations below a central value of the distribution. To determine whether the initial touch signal threshold value requires adjusting may comprise determining whether a statistically significant difference exists between the tentative touch signal threshold value, and the initial value set in step 402. If no statistically significant difference exists, then the initial value is not adjusted.

If it is determined that the initial touch signal threshold requires adjusting, then the calibrated value set in step 408 may be the tentative touch signal threshold value, for example. Other methods of setting the calibrated value may include determining an average or mean of the initial and tentative value, or of a number of tentative values determined based on different samples, and/or an initial value. Various statistical techniques of determining a calibrated value may be apparent to one skilled in the art.

Thus, the present disclosure may enhance a user's experience, and reduce frustration with touchscreen devices. For example, in typing, a user may gently rest his fingers on the virtual keyboard, without triggering a touch sensing.

It should be understood, of course, that the foregoing relates to exemplary embodiments of the invention and that modifications may be made without departing from the spirit and scope of the invention as set forth in the following claims.

We claim:

1. A touchscreen device comprising:
a touch sensitive screen; and
a processor configured to receive a touch signal effectuated by a user touching event, through the touch sensitive screen,
wherein the touch sensitive screen enables a user to control processing functions of the processor through a detected intentional touching event effectuated by the user,
wherein the processor is configured to determine whether the touch signal is associated with an intentional touching event by determining whether a touch strength signal value of the touch signal is above or below a touch signal threshold value,
wherein a touch strength signal value above the touch signal threshold value is determined to be associated with an intentional touching event,
wherein the touch signal threshold value is calibrated by the processor based on user touchscreen input by:
collecting at least one sample of touch strength signal values over at least one user input session;
analyzing the at least one sample to determine if an initial touch signal threshold value requires adjusting, wherein analyzing the at least one sample comprises determining a central value based on a statistical analysis of the at least one sample of touch strength signal values; and
determining a calibrated touch signal threshold value based on the analysis of the at least one sample,
wherein the calibrated touch strength signal value may be the initial touch signal threshold value, or an adjusted touch strength signal value based on the central value, and
wherein the calibrated touch signal threshold value is used in determining an intentional touching event.

2. The device of claim 1, wherein the initial touch signal threshold value is set at a minimum value for a detectable touch signal on the touchscreen.

3. The device of claim 1, wherein the initial touch signal threshold value is a previously adjusted touch strength signal value.

4. The device of claim 1, wherein the touch signal threshold value is function specific, touch manner specific, user specific, or a combination thereof.

5. The device of claim 4, wherein the touch strength signal threshold value is determined for typing on a virtual keyboard.

6. The device of claim 5, wherein the touch strength signal threshold value is determined for a specific key of the virtual keyboard.

7. The device of claim 1, wherein the at least one sample of touch strength signal values comprises a capacitance value associated with a user touch event.

8. The device of claim 1, wherein analyzing the sample data comprises determining a tentative threshold, and wherein the tentative threshold is at least 2 standard deviations below the central value.

9. A computer-implemented method for determining an intentional touching event on a touchscreen device, comprising executing on a processor of the device the steps of:
receiving, by a processor, a touch signal effectuated by a user touching event, through a touch sensitive screen of the touchscreen device, the touch signal having a touch signal value;
comparing, by the processor, a strength of the touch signal value associated with the touching event to a calibrated touch signal threshold value, wherein the calibrated touch signal threshold value is determined by adjusting a touch signal threshold value based on a user's active input through the touch sensitive screen of the touchscreen device;
determining, by the processor, if the touching event is an intentional or unintentional touching event, wherein if the strength of the touch signal value falls below the calibrated touch signal threshold value, the touching event is determined to be unintentional; and
enabling the user to control a processing function of the touchscreen device, the processing function being associated with the user touching event, if the touching event is determined to be intentional.

10. The method of claim 9, further comprising:
collecting at least one sample of touch strength signal values, over at least one user input session, wherein the sample of touch strength signal values comprises a plurality of user input values.

11. The method of claim 10, further comprising analyzing the sample data to obtain a tentative threshold based on a statistical analysis of the plurality of user input values.

12. The method of claim 9, wherein the touch signal threshold value is function specific, touch manner specific, user specific, or a combination thereof.

13. The method of claim 9, wherein the touch signal threshold value is determined for typing on a virtual keyboard.

14. The method of claim 13, wherein the touch strength signal threshold value is determined for a specific key of the virtual keyboard.

15. The method of claim 9, wherein the touch signal value is determined by capacitance sensing.

16. The method of claim 9, wherein a user's active input comprises a touching of the touchscreen with the user's finger or touchscreen input instrument.

17. A non-transient computer readable medium containing program instructions for causing a computer to perform a method of determining an intentional touching event on a touchscreen device, the method comprising:
receiving a touch signal effectuated by a user touching event, through a touch sensitive screen of the touchscreen device, the touch signal having a touch signal value;
comparing a strength of the touch signal value associated with the touching event to a calibrated touch signal threshold value, wherein the calibrated touch signal threshold value is determined by adjusting a touch signal threshold value based on a user's active input through the touch sensitive screen of the touchscreen device;
determining if the touching event is an intentional touching event, wherein if the strength of the touch signal value falls above the calibrated touch signal threshold value, the touching event is determined to be intentional; and
enabling the user to control a processing function of the touchscreen device associated with the user touching event, if the touching event is determined to be intentional.

18. The non-transient computer readable medium of claim 17, wherein the touch signal value is based on capacitance sensing.

19. The non-transient computer readable medium of claim 17, wherein adjusting a touch signal threshold value comprises a statistical analysis of the user's active input.

20. The non-transient computer readable medium of claim 17, wherein the touch signal threshold value is determined for typing on a virtual keyboard of the touch sensitive screen.
